(19) United States
(12) Patent Application Publication
(10) Pub. No.: US 2019/0363669 A1
(43) Pub. Date: Nov. 28, 2019

(54) SOLAR TRACKING SYSTEM FOR A SOLAR PHOTOVOLTAIC POWER PLANT

(71) Applicant: Alion Energy, Inc., Richmond, CA (US)

(72) Inventors: Craig B. E. Wildman, Kensington, CA (US); Rodney Hans Holland, Novato, CA (US); Søren Jensen, Corte Madera, CA (US)

(21) Appl. No.: 16/412,081

(22) Filed: May 14, 2019

Related U.S. Application Data
(60) Provisional application No. 62/671,914, filed on May 15, 2018.

(51) Int. Cl. H02S 20/32; F16M 11/22; F16M 11/10; F24S 25/65; F24S 30/425; F24S 50/20

(52) U.S. Cl. CPC H02S 20/32; F16M 11/22; F16M 11/10; F24S 2025/02; F24S 30/425; F24S 50/20; F24S 25/65

(57) ABSTRACT

Solar trackers and methods for assembling same are described herein. A pair of ballast blocks, simultaneously using a slip-form paver having a cut-off blade, by positioning the paver at a start point of the pair of ballast blocks. The cut-off blade is oriented in a closed position, halting flow of concrete. The slip-form paver is advanced to an end point of the pair of ballast blocks. While advancing the slip-form paver, the cut-off blade is simultaneously moved to an open position. The open position permits flow of the concrete through the mold depositing onto a solar tracker location. After reaching the end point, the cut-off blade is moved to the closed position. Grooves oriented lengthwise are formed in each ballast block. A leg structure of the solar tracker is secured into the grooves.

### CROSS-REFERENCE TO RELATED APPLICATION

This application claims the benefit of the following application, the entire contents of which are incorporated by reference herein: U.S. Provisional Application No. 62/671,914, filed May 15, 2018 and entitled “Solar Tracking System for a Solar Photovoltaic Power Plant.”

### FIELD

Certain configurations of the present subject matter pertain to solar photovoltaic (PV) power plants.

### BACKGROUND

Solar PV plants use solar PV modules to collect light from the sun and convert it into electric power. A mechanical support structure can be useful to properly position the solar PV modules. A rotating mechanism incorporated into a mounting structure can be used to change the orientation of the solar PV modules to give them a better view of the sun through the day, thereby increasing light collection and electricity generation. The mechanical structure and tracking mechanism can be costly, and reducing the cost of the system can be challenging.

### SUMMARY

In one aspect, a solar tracker includes a solar PV module configured to rotate about a rotational axis, a first leg structure and a second leg structure secured to the solar PV module at a first end, and a first pair of ballast blocks secured to a second end of the first leg structure and a second pair of ballast blocks secured to a second end of the second leg structure. Each pair of ballast blocks being made of concrete. The first pair of ballast blocks are spatially separated from the second pair of ballast blocks and oriented parallel to the rotational axis. Each ballast block of the first pair of ballast blocks and the second pair of ballast blocks includes a groove oriented lengthwise. The groove secures the first leg structure and the second leg structure to the respective pair of ballast blocks.

In some variations, the groove further can include an adhesive. The adhesive can secure the second end of the first leg structure and the second end of the second leg structure to the respective pair of ballast blocks.

In other variations, a drive shaft can be positioned within each leg structure. The drive shaft can be configured to rotate the solar PV module about the rotational axis.

In another aspect, a solar tracking system includes a first solar tracker and a second solar tracker. Each solar tracker has a solar PV module configured to rotate about a rotational axis, a first leg structure and a second leg structure secured to the solar PV module at a first end, a pair of ballast blocks made of concrete secured to the first leg structure of the first solar tracker and a second leg structure of the second solar tracker, and oriented parallel to the rotational axis. Each ballast block of the pair of ballast blocks includes a groove oriented lengthwise. The groove secures the first leg structure of the first solar tracker and the second leg structure of the second solar tracker.

In some variations, the groove further can include an adhesive. The adhesive can secure the first leg structure of the first solar tracker and the second leg structure of the second solar tracker.

In some variations, each solar tracker further includes a drive shaft positioned within each leg structure. The drive shaft can be configured to rotate the solar PV module about the rotational axis.

In yet another aspect, a method of assembling a solar tracker includes forming a pair of ballast blocks, simultaneously using a slip-form paver comprising a cut-off blade. The pair of ballast blocks are made of concrete and are formed by positioning the slip-form paver at a start point of the pair of ballast blocks. The cut-off blade is initially in a closed position. The closed position halts flow of concrete. The slip-form paver is advanced to an end point of the pair of ballast blocks. While advancing the slip-form paver, the cut-off blade is moved to an open position. The open position permits flow of the concrete through the mold depositing onto a solar tracker location. After reaching the end point, the cut-off blade is moved to the closed position. Grooves are formed lengthwise in each ballast block. A leg structure of the solar tracker is secured into the grooves.

In some variations, forming the grooves includes cutting each ballast block after formation.

In other variations, the mold includes shapes that are inverse representations of the grooves.

In some variations, the method also includes applying a curing compound to the pair of ballast blocks.

In other variations, the leg structure includes feet. Securing of the leg structure of the solar tracker into the grooves includes inserting the feet of the leg structure into the grooves and applying, after the inserting, an adhesive into the grooves.

In some variations a second pair of ballast blocks can be formed by repeating the positioning, advancing, moving, and depositing, wherein the second pair of ballast blocks are spatially separated from the first pair of ballast blocks.

In other variations, GPS data is used to control the moving of the cut-off blade.

In some variations, the mold includes one or more vibrators and the vibrators are controlled by GPS data.

In another aspect, a solar tracker system includes a solar PV module configured to rotate about a rotational axis, a pair of leg structures secured to the solar PV module at a first end, each leg structure comprising two feet at a second end of the leg structure, and a pair of ballast blocks comprising a lengthwise groove. Each foot is secured to the pair of ballast blocks by being inserted into the lengthwise groove. Each ballast block includes an elongated reinforcement bar embedded in the ballast block beneath the lengthwise groove. The pair of ballast blocks are oriented parallel to the rotational axis.

In yet another aspect, a solar tracking system includes a first solar tracker and a second solar tracker coupled to each other. Each solar tracker includes a solar PV module configured to rotate about a rotational axis, a pair of leg structures secured to the solar PV module at a first end, each leg structure having two feet at a second end of the leg structure, and a pair of ballast blocks having a lengthwise groove. Each foot is secured to the pair of ballast blocks by being inserted into the lengthwise groove. Each ballast block includes an elongated reinforcement bar embedded in the ballast block beneath the lengthwise groove.

In another aspect, a solar tracker system includes a solar PV module configured to rotate about a rotational axis, a pair of leg structures secured to the solar PV module at a first end, each leg structure comprising two feet at a second end of the leg structure, and a pair of ballast blocks including a lengthwise groove. Each foot is secured to the pair of ballast blocks by being inserted into the lengthwise groove. The pair of ballast blocks are oriented perpendicular to the rotational axis.

In yet another aspect, a solar tracker system includes a solar PV module configured to rotate about a rotational axis, a pair of leg structures secured to the solar PV module at a first end, each leg structure comprising two feet at a second end of the leg structure, and a pair of ballast blocks each having a lengthwise groove and a joint positioned at a midpoint. Each foot is secured to the pair of ballast blocks by being inserted into the lengthwise groove. Each ballast block further includes an elongated reinforcement bar within the groove at the midpoint. The pair of ballast blocks are oriented parallel to the rotational axis.

In another aspect, a solar tracker system includes a solar PV module configured to rotate about a rotational axis, a pair of leg structures secured to the solar PV module at a first end, each leg structure comprising two feet at a second end of the leg structure, and a pair of ballast blocks having a groove across the width of each ballast block. Each foot is secured to the pair of ballast blocks by being inserted into the groove. The pair of ballast blocks are oriented perpendicular to the rotational axis.

In yet another aspect, a solar tracker system includes a solar PV module configured to rotate about a rotational axis, a pair of leg structures secured to the solar PV module at a first end, each leg structure having two feet at a second end of the leg structure, each foot having (i) a plurality of holes and (ii) interlocking protrusions on a side of each foot, and a pair of ballast blocks oriented perpendicular to the rotational axis. Each ballast block having a material and an exterior form surrounding the material, the exterior form having slots. The interlocking protrusions are inserted within the slots and the material fills the exterior form and the plurality of holes.

In another aspect, a solar tracker system includes a solar PV module configured to rotate about a rotational axis, a pair of leg structures secured to the solar PV module at a first end, each leg structure having two feet at a second end of the leg structure, each foot having a plurality of notches, and four circular forms having a reinforcement bar positioned across each circular form and secured within each form. A notch of the plurality of notches is positioned on top of the reinforcement bar, and the four circular forms are filled with a material.

In yet another aspect, a method of assembling a solar tracker includes forming four circular ballast blocks using forms. The ballast blocks are formed by inserting leg structures of the solar tracker into each form and pouring material into each form. A curing compound is applied to the four circular ballast blocks after formation. Solar PV modules are secured to the leg structures. A drive shaft of the solar tracker is coupled to another drive shaft of another solar tracker. Electrical wiring of the solar tracker is installed.

In another aspect, a solar tracker system includes a solar photovoltaic (PV) module configured to rotate about a rotational axis, a pair of leg structures secured to the solar PV module at a first end, each leg structure comprising two feet at a second end of the leg structure, and a pair of pre-cast ballast blocks. Each foot is secured to the pair of ballast blocks by fastener drilled vertically into each pre-cast ballast block. The pair of ballast blocks are oriented parallel to the rotational axis.

In yet another aspect, a solar tracker includes a solar photovoltaic (PV) module configured to rotate about a rotational axis, a pair of leg structures secured to the solar PV module at a first end, each leg structure comprising two feet at a second end of the leg structure, and a pair of pre-cast ballast blocks. Each foot is secured to the pair of ballast blocks by fastener surrounding an exterior of each pre-cast ballast block. The pair of ballast blocks are oriented parallel to the rotational axis.

In another aspect, a solar tracker system includes a solar PV module configured to rotate about a rotational axis, a pair of leg structures secured to the solar PV module at a first end, each leg structure comprising two feet at a second end of the leg structure, and a pair of pre-cast ballast blocks. Each foot is secured to the pair of ballast blocks by a reinforcement bar extending horizontally into each pre-cast ballast block. The pair of ballast blocks are oriented parallel to the rotational axis.

### BRIEF DESCRIPTION OF THE DRAWINGS

FIG. 1 schematically illustrates a perspective view of components of a solar tracker, according to exemplary configurations provided herein;

FIG. 2 schematically illustrates a perspective view of components of a solar tracking system, according to exemplary configurations provided herein;

FIG. 3 is an example process flow chart for assembling a solar tracker, such as the solar tracker described in FIG. 1;

FIG. 4 schematically illustrates an example slip-form paver mold;

FIG. 5A schematically illustrates a side view of slip-form paver mold having a cut-off blade in a closed position;

FIG. 5B schematically illustrates a side view of slip-form paver mold having a cut-off blade in an open position;

FIG. 6A schematically illustrates a perspective view of solar tracker, according to exemplary configurations provided herein;

FIG. 6B schematically illustrates a cut-away perspective view of the solar tracker foot and ballast block of FIG. 6A, according to exemplary configurations provided herein;

FIG. 7 schematically illustrates a perspective view of components of a solar tracking system, according to exemplary configurations provided herein;

FIG. 8 schematically illustrates a perspective view of another solar tracker that can be used to support and rotate solar modules, according to exemplary configurations provided herein;

FIGS. 9A and 9B schematically illustrate a solar tracker that can be used in a solar tracker system as is illustrated in FIG. 7, according to exemplary configurations provided herein;

FIG. 10 schematically illustrate a perspective view of another example solar tracker that can be used to support and rotate solar modules, according to exemplary configurations provided herein;

FIG. 11 is a process flow diagram illustrating a method of assembling a solar tracker such as those described in FIGS. 9A-9B, according to exemplary configurations provided herein;

FIG. 12A schematically illustrates an example solar tracker that can be used to support and rotate solar modules, according to exemplary configurations provided herein;

FIG. 12B illustrates a perspective view of foot of solar tracker;

FIG. 12C schematically illustrates a perspective view of foot secured into place into ballast form;

FIG. 13A schematically illustrates an example solar tracker that can be used to support and rotate solar modules, according to exemplary configurations provided herein;

FIG. 13B schematically illustrates an example ballast form of solar tracker;

FIG. 13C schematically illustrates a leg which can assist with leveling the solar tracker in a stow position;

FIG. 14A-14B schematically illustrate perspective views of a solar tracker that can be used to support and rotate solar modules, according to exemplary configurations provided herein;

FIG. 15 is an example process flow chart for assembling a solar tracker having ballast block formed with a form;

FIG. 16 schematically illustrates a perspective view of another solar tracker that can be used to support and rotate solar modules, according to exemplary configurations provided herein;

FIG. 17 schematically illustrates a perspective view of another example solar tracker that can be used to support and rotate solar modules, according to exemplary configurations provided herein; and

FIG. 18 schematically illustrate perspective views of a solar tracker that can be used to support and rotate solar modules, according to exemplary configurations provided herein.

### DETAILED DESCRIPTION

Configurations of the present subject matter provide systems and methods for supporting and rotating solar PV modules. However, it should be appreciated that the systems and methods provided herein can effectively be used for solar PV structures that do not rotate or track the sun as well. The disclosed systems and methods alternatively can be used for concentrating solar thermal collectors, including both tracking and non-tracking systems.

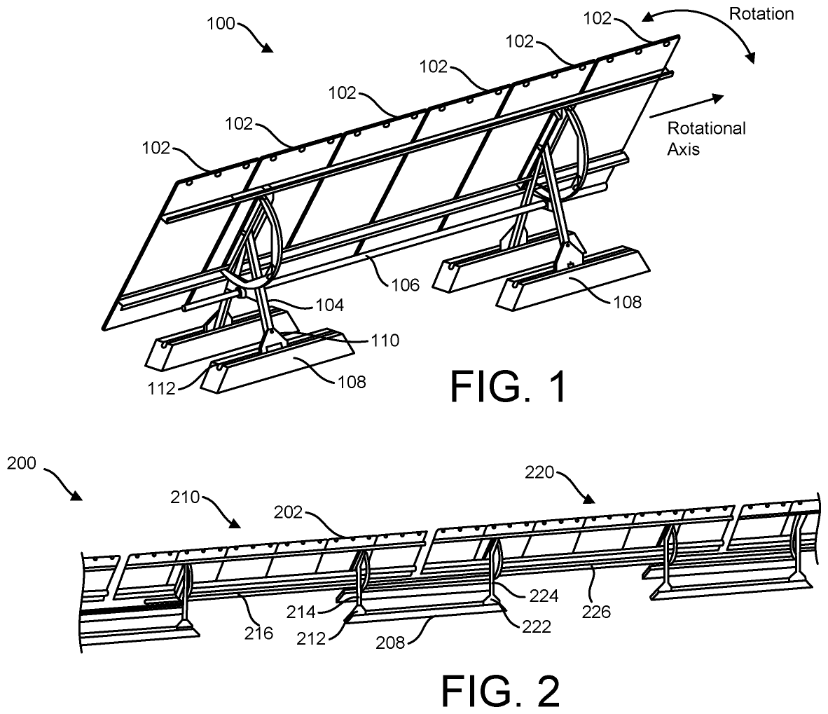

FIG. 1 schematically illustrates a perspective view of components of a solar tracker 100, according to exemplary configurations provided herein. Solar tracker 100 includes a solar panel module having a number of solar photovoltaic (PV) modules 102, a leg structure 104, a drive shaft 106, and ballast blocks 108. Solar tracker 100 can be secured in place via a foundation made up of legs 104, feet 110, and ballast blocks 108. As illustrated in FIG. 1, solar tracker 100 has four legs, but more or fewer legs can be used as well. The ballast blocks 108 need not necessarily be all the same size as one another. For example, larger ballast blocks can be used for a solar tracker positioned in a location where the tracking system can be exposed to higher wind forces, and smaller ballast blocks can be used for a solar tracker positioned in a location where the tracker can be exposed to lower wind forces. For example, tracking systems positioned on the periphery of a solar field can be exposed to higher wind forces than trackers positioned in the interior of the solar field. The use of such smaller ballast blocks can, for example, provide a substantial reduction in ballast mass for a suitable number of solar tracker sections in a solar field, e.g., for a majority (greater than 50%) or greater than a large majority (greater than 75%) of solar tracker sections in a solar field. The ballast blocks can be made of or include concrete or another suitably cheap and dense material or combination of materials selected to inhibit sliding or overturning of the solar tracker under a defined level of wind forces.

The solar PV module 102 can be secured to legs 104. Each leg 104 can be connected to a foot 110. The foot 110 can provide a connection to a ballast block 108. In the variation illustrated in FIG. 1, the ballast block 108 includes a groove 112 cut into the top. The foot 110 can fit inside the groove 112. Foot 110 can be secured within groove 112 using an adhesive. The ballast block 108 can be coupled to multiple feet and positioned parallel to a rotational axis of the solar tracker 100. Drive shaft 106 can be rotatably secured within the leg structure. Drive shaft 106 can be powered by an appropriately sized motor. Solar PV modules 102 can be rotated about the rotational axis through movements of the drive shaft 106.

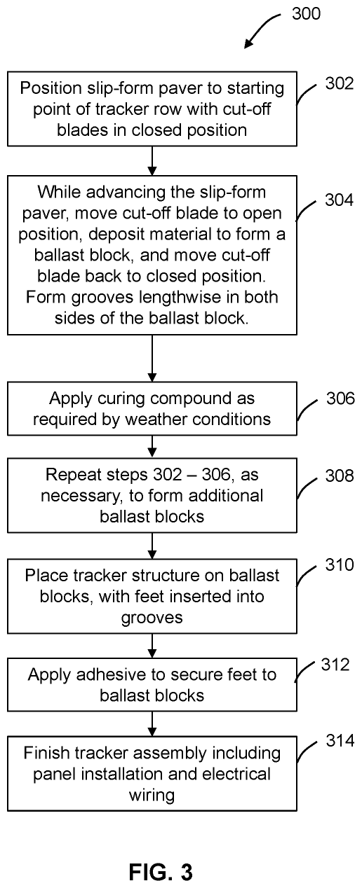

In the example illustrated in FIG. 1, ballast blocks 108 are arranged to form a foundation in discrete segments in two parallel rails. Ballast blocks 108 can be formed using a slip-form paver as described in more detail in FIG. 3. A slip-form paver can drive parallel to the rotational axis of the solar tracker 100 and pour two parallel rows or rails of ballast blocks 108 simultaneously. As previously described, the material poured by the slip-form paver can include concrete or another suitably cheap and dense material or combination of materials selected to inhibit overturn of the solar tracker under a defined level of wind forces. The material pouring can be started and stopped to form ballast blocks 108, as described in more detail in FIG.3.

In the presence of a strong wind blowing perpendicular to the rotational axis, certain solar tracking systems can be susceptible to overturn, uplift, sliding, and/or other failure of its foundation. By connecting multiple feet lengthwise in a manner such as illustrated in FIG. 2, the wind-loaded tributary area of the solar tracking system that corresponds to one ballast block can be increased, and a larger tributary area can result in lower wind loading during wind gust events, thus providing a substantial reduction in wind loading and therefore a substantial reduction in ballast mass needed to inhibit overturn of the solar tracker.

FIG. 2 schematically illustrates a perspective view of components of a solar tracking system 200, according to exemplary configurations provided herein. A plurality of solar trackers, such as solar tracker 210 and solar tracker 220, can be coupled together with drive shaft couplings 216 and 226 and can be driven by a motor (not shown). Each solar tracker 210, 220 can include a number of solar PV modules 202. Solar tracker 210 can be supported by a leg structure having legs 214 and feet 212. Solar tracker 220 can be supported by a leg structure having legs 224 and feet 222. As illustrated in FIG. 2, ballast block 208 can be shared by both solar trackers 210, 220. In other words, feet 212 of solar tracker 210 and feet 222 of solar tracker 220 can each be secured to the same ballast block 208. The sharing of ballast block 208 between two solar trackers 210, 220 can result in a larger tributary area for wind loading. In other words, the force of a gust of wind can be averaged over a larger area of solar panels. This averaging effect reduces the gust force per unit area, thereby reducing the overturn load on the ballast block 208.

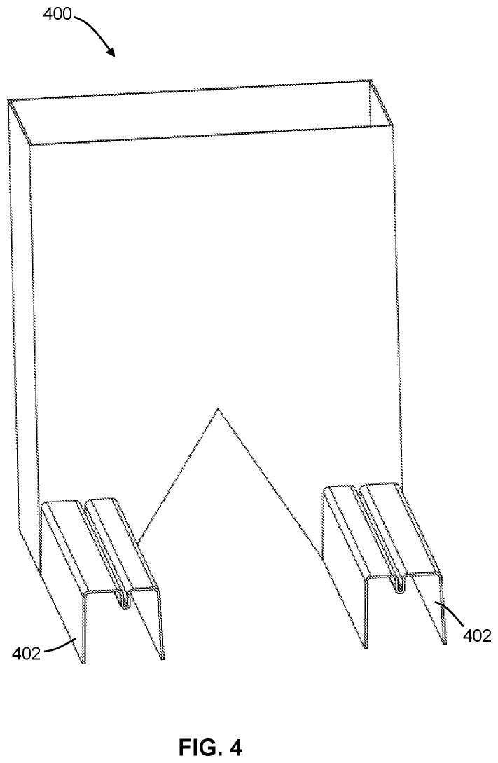

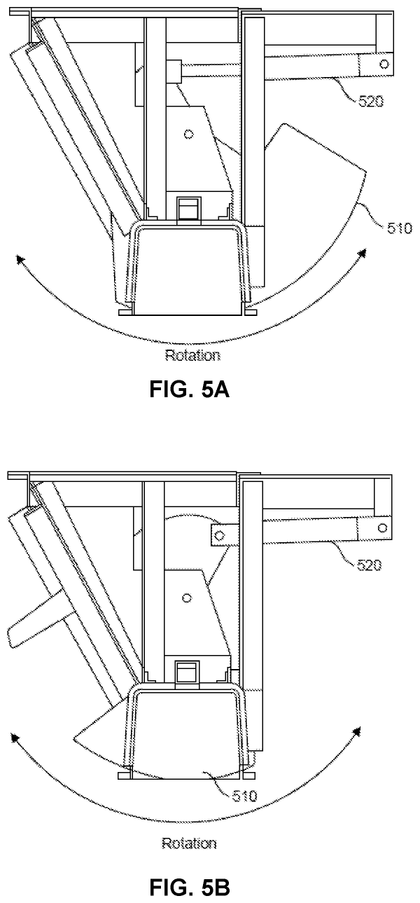

FIG. 3 is an example process flow chart 300 for assembling a solar tracker, such as the solar tracker 100 described in FIG. 1. A slip-form paver can be used to simultaneously pour two ballast blocks parallel to each other. The slip-form paver can use a mold, such as the slip-form paver mold 400 illustrated in FIG. 4. Two ballast blocks can be shaped by pouring the material into a mold with two profiles to form the two ballast blocks 402. More specifically, a concrete mixer truck holding material to form the ballast block can feed the material into a slip-form paver. The slip-form paver mold 400 can be positioned, at 302, at a starting point for a tracker row. The slip-form paver mold 400 can include a cut-off blade 510 as illustrated in FIGS. 5A-5B. The cut-off blade 510 can be used to control the flow of the material of the slip-form paver to form the ballast blocks.

FIG. 5A schematically illustrates a side view of slip-form paver mold 400 having a cut-off blade 510 in a closed position. The closed position can be the initial position of the cut-off blade 510 during formation of the ballast blocks. In other words, when the slip-form paver is positioned at a starting point, the cut-off blade 510 can be in the closed position.

The slip-form paver can be advanced, at 304, from the starting position to begin formation of the ballast blocks. In order to lay the ballast blocks, the slip-form paver mold 400 can be advanced from the starting point for a set period of time to achieve a design length for the ballast blocks. Once the ballast blocks are of a desired design length, the cut-off blade 510 is moved back to a closed position using hydraulic piston 520. For example, the cut-off blade 510 can be rotated or slid between positions. In some variations, GPS data can be used to control the rotational position of cut-off blade 510 in the slip-form paver mold 402 (e.g., controlling whether cut-off blade 510 is open as illustrated in FIG. 5B or closed as illustrated in FIG. 5A or moving between those two positions). One or more vibrators (not shown) can be used inside the slip-form paver mold 400 to assist with the material flow and/or to modify the density of the flowing material. GPS data can also be used to control the one or more vibrators (e.g., turn on/off the vibrators, increase/decrease the vibration intensity). The number of vibrators used can depend upon the size and arrangement of the slip-form paver mold 400, on concrete conditions, and on other factors.

Once the ballast block is formed, in some variations such as the solar tracker 100, a groove can be cut into ballast block using a cutting tool such as a saw or any other cutting tool capable of making a groove without structurally damaging the ballast block. The groove can be cut while the concrete is wet, early in its cure process, or after the concrete has cured. After the ballast block is formed, and in some variations after the groove is cut into the ballast block, the material can be cured, at 306, using an appropriate curing compound. Additional ballast blocks can be formed by repeating, 308, steps 302-306. The leg structures, more specifically the feet, can then be placed, at 310, into the grooves. In the variation illustrated in FIG. 1, an adhesive such as an epoxy or glue can be applied, at 312, to secure the feet to the ballast block. Once the leg structure is secured to the ballast block, the remaining aspects of the solar tracker assembly can be finished, at 314, such as installation of the solar PV modules and required electrical wiring.

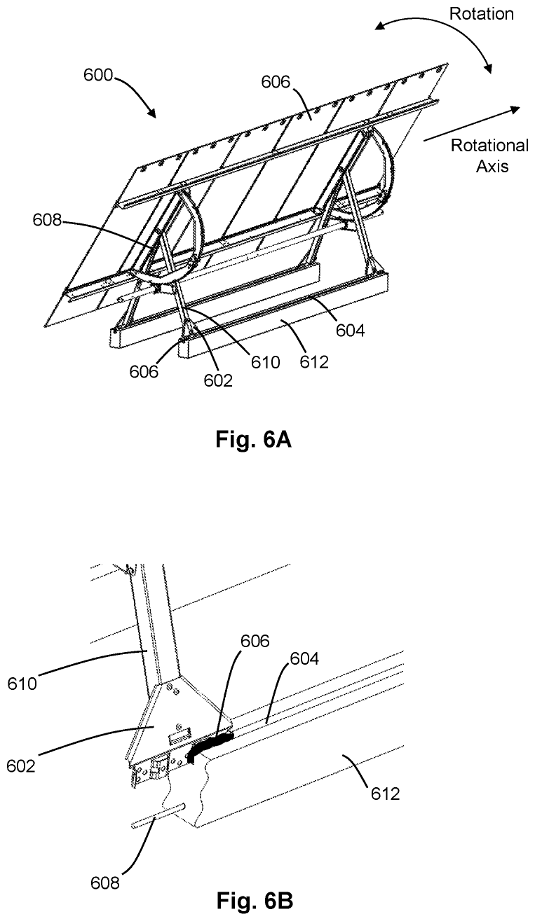

FIG. 6A schematically illustrates a perspective view of solar tracker 600, according to exemplary configurations provided herein. The solar tracker legs 610 can be connected to a foot 602, and this foot piece can provide a connection to a ballast block 612. In this configuration, the ballast block includes a groove 604 on the top, and the foot 602 can fit inside the groove and can be secured therein by adhesive 606. The groove 604 can be cut into ballast block 602 after formation using, for example, a saw or any other cutting tool capable of making a groove without structurally damaging the ballast block. The ballast block 612 can be coupled to multiple feet parallel to the axis of rotation of the solar tracker. The ballast block 612 can be formed using a slip-form paver.

FIG. 6B schematically illustrates a cut-away perspective view of the solar tracker foot 602 and ballast block 612 of FIG. 6A, according to exemplary configurations provided herein. The foot 602 is shown positioned in the groove 604 with adhesive 606 filling the space between the foot and the groove walls. Features, such as holes and protrusions, optionally can be included in the foot design, for example to facilitate a mechanical lock between the adhesive 606 and foot 602 and to enhance the shear strength of the adhesive-ballast joint. The ballast block 612 can be made of concrete or other suitable material(s). One or more elongated pieces of reinforcing bars, e.g., rebar, 608 optionally can be embedded in a concrete ballast to provide tensile and flexural strength if the concrete were to crack. The reinforcing bars 602 optionally can be pre-tensioned so as to preload the concrete ballast in compression, thereby increasing its tensile and flexural strength. If concrete is used as the ballast, the concrete can be formed in any suitable manner, for example by casting it in place, pre-casting it and then transporting it to site, extruding it with extrusion machines and then transporting it to site, or slip-forming it with a slip-form paver or curbing machine.

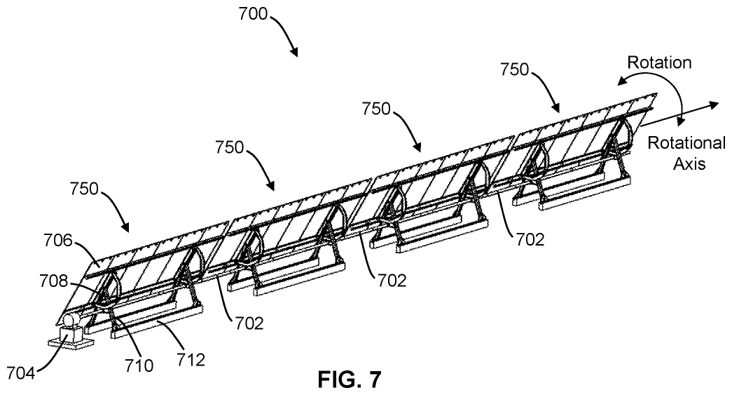

FIG. 7 schematically illustrates a perspective view of components of a solar tracking system 700, according to exemplary configurations provided herein. A plurality of solar trackers 750 can be coupled together with drive shaft couplings 702 and can be driven by a motor with a gear system 704. Each solar tracker 750 can include a number of solar PV modules 706. A leg structure 708 can be used to support the solar PV modules 706 and allow sufficient freedom of motion for the tracking operation. Each solar tracker can include legs 710 that are connected to ballast blocks 712 that can serve as a foundation. Solar tracking system 700 differs from the solar tracking system 200 in that each solar tracker 700 has its own ballast block rather than sharing the ballast block between two solar trackers. As illustrated in FIG. 7, four legs per solar tracker are shown, but more or fewer legs can be used as well. The ballast blocks 712 need not necessarily be all the same size as one another. For example, larger ballast blocks can be used for a solar tracking system positioned in a location where the tracker can be exposed to higher wind forces, and smaller ballast blocks can be used for a the solar tracker positioned in a location where the tracker can be exposed to lower wind forces. For example, trackers positioned on the periphery of a solar field can be exposed to higher wind forces than trackers positioned in the interior of the solar field. The use of such smaller ballast blocks can, for example, provide a substantial reduction in ballast mass for a suitable number of solar tracker sections in a solar field, e.g., for a majority (greater than 50%) or greater than a large majority (greater than 75%) of solar tracker sections in a solar field. The ballast can be made of or include concrete or another suitably cheap and dense material or combination of materials selected to inhibit overturn of the solar tracker under a defined level of wind forces.

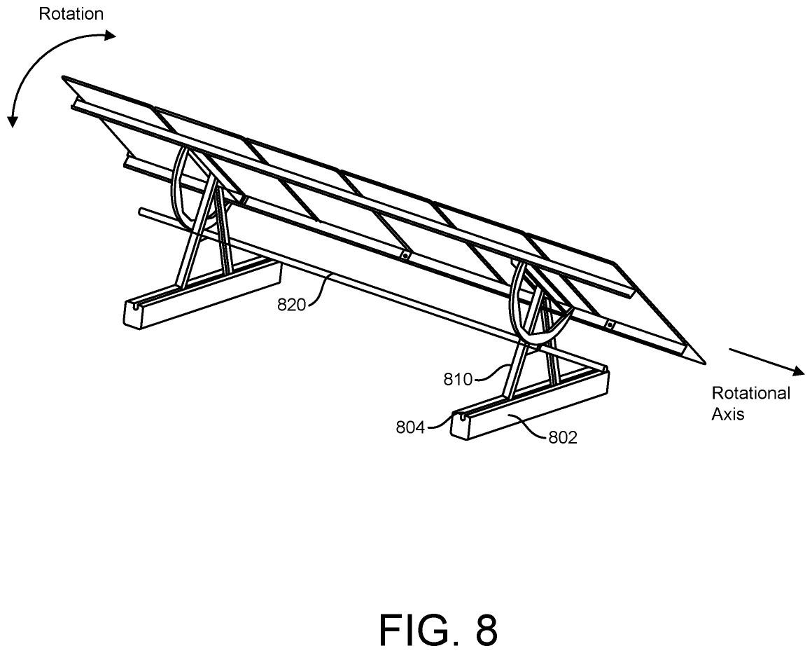

FIG. 8 schematically illustrates a perspective view of another solar tracker 800 that can be used to support and rotate solar modules, according to exemplary configurations provided herein. Solar tracker 800 includes legs 810 that can connect to a ballast block 802. Ballast block 802 can be formed perpendicular to the rotational axis using a slip-form paver. A groove 804 can be formed within ballast block 802 through the use of slip-form paver mold 400, rather than cutting the ballast block 802 after formation. Legs 810 can be secured within groove by feet (not shown). An adhesive can be laid within groove 804 to secure the feet to ballast block 802.

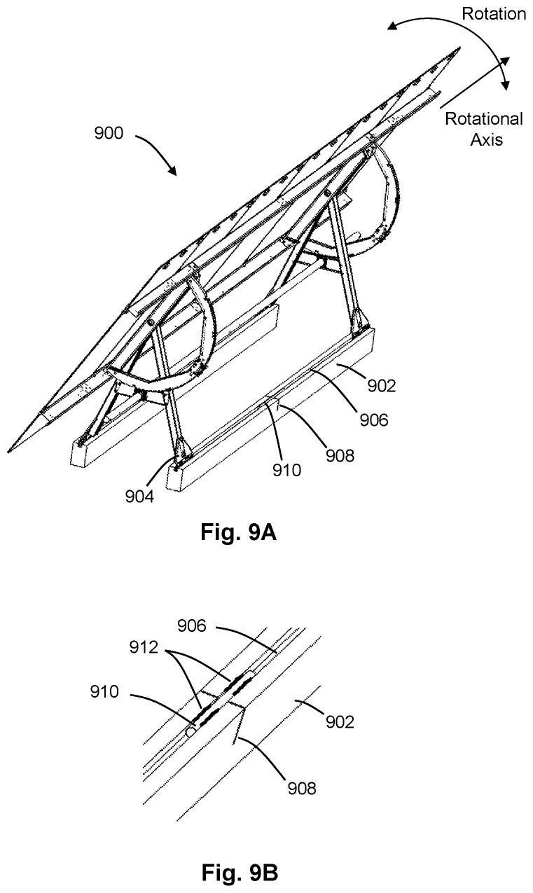

FIGS. 9A and 9B schematically illustrate a solar tracker 900 that can be used in a solar tracker system as is illustrated in FIG. 7, according to exemplary configurations provided herein. FIG. 9B schematically illustrates a detailed, perspective view of a ballast block 902 in the vicinity of a control joint 908. Solar tracker 900 can include a ballast block 902 in which feet 904 can connect the solar tracker structure to the ballast block. In the configuration illustrated in FIGS. 9A and 9B, the feet 904 can be adhered to the ballast block 902 in a groove 906. A control joint 908 can be used to guide cracking to occur at the control joint rather than in other locations. The control joint 908 can be formed by cutting the ballast block 902 after it is formed or by other suitable process. The control joint 908 can be formed partway through the ballast, as is illustrated, and this can structurally weaken the ballast block 902. If the ballast block 902 cracks at the control joint 908, then the ballast block 902 can act as two separate pieces from a structural point of view. Instead of a control joint, in another configuration the ballast can be simply formed of two pieces that butt up to one another at the location of the control joint. In either configuration, the ballast block 902 is not expected to transfer loads all the way between one foot 904 and the other if it is unreinforced.

Continuing with FIGS. 9A and 9B, a rod 910 can be located in the groove 906 across the control joint 908 and adhered to the groove 906 on both sides of the control joint 908 with adhesive 912. The rod 910 can be or include a solid bar or a hollow tube. The rod 910 can be used to structurally connect the ballast block 902 across the control joint 908. For example, by structurally connecting the ballast block 902 at its weak point with rod 910, the ballast block 902 can act as a single structural member connecting multiple feet of the solar tracker 900 lengthwise along the tracking axis. This can increase the wind-loaded tributary area of the solar tracker served by a single ballast piece, thereby reducing the effective peak wind loading on the structure for the purpose of sizing the ballast block 902. The rod 910 optionally can be used in addition to or instead of reinforcing bars embedded in the ballast block 902 as illustrated in FIG. 9B.

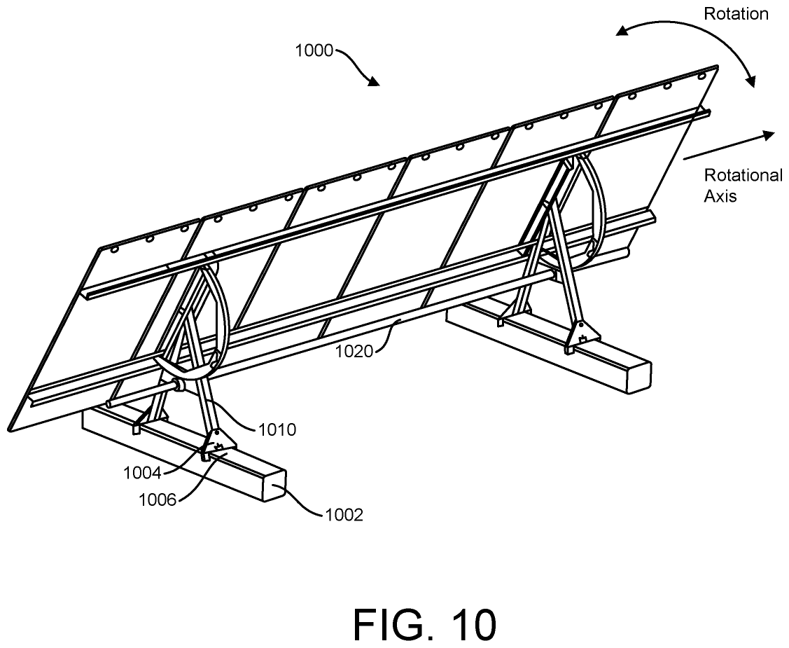

FIG. 10 schematically illustrate a perspective view of another example solar tracker 1000 that can be used to support and rotate solar modules, according to exemplary configurations provided herein. The solar tracker legs 1010 can be connected to a foot 1004. Foot 1004 can provide a connection to a ballast block 1002. In this configuration, the ballast block 1002 is perpendicular to a rotational axis of solar tracker 1000. The rotational axis can be defined by the drive shaft 1020. Ballast block 1002 can be formed using a slip-form paver. A groove 1006 can be cut into ballast block 1002 after formation using, for example, a saw or any other cutting tool capable of making a groove without structurally damaging the ballast block. As illustrated in FIG. 10, ballast block 1002 can be positioned perpendicular to the rotational axis and the groove 1006 can be positioned across the width of the ballast block 1002, parallel to the rotational axis.

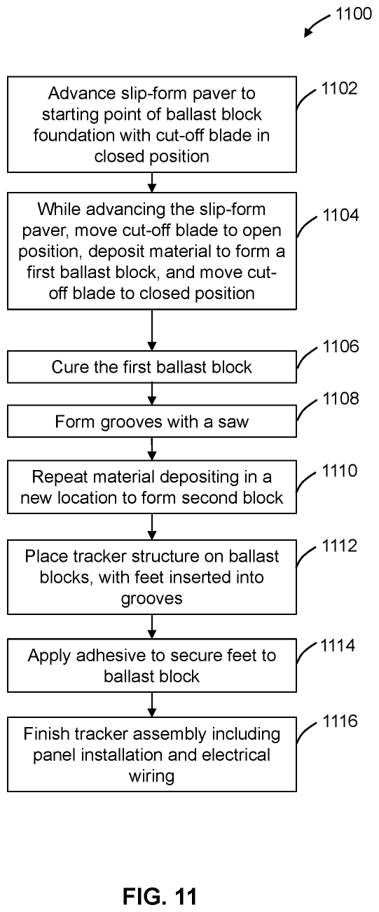

FIG. 11 is a process flow diagram illustrating a method 1100 of assembling a solar tracker such as those described in FIGS. 9A-9B, according to exemplary configurations provided herein. A slip-form paver is advanced, at 1102, to a starting position to form a first ballast block. At the starting position, slip-form paver has a cut-off blade 510 in a closed position as illustrated in FIG. 5A. While advancing the slip-form paver 1120 (e.g., moving the paver from point A to point B along a guided path), cut-off blade 510 is moved to an open position, at 1104, and material is deposited to form a first ballast block. Once the first ballast block is formed (e.g., the design length of the ballast block is achieved), the material valve is closed. After the material is poured to form the first ballast block, the first ballast block is cured, at 1106, by applying one or more curing compounds to ensure sufficient hydration of the concrete. Optionally, in some variations, grooves in the first ballast block can be cut, at 1108, using any cutting device capable of making the grooves without cracking or damaging ballast block. In other variations, grooves in the first ballast block can be formed using the slip-form paver 400. Some variations may not include any grooves. A second ballast block can be formed by repeating, at 1110, the material deposition and curing as described in steps 1104-1106. In variations which have grooves, the feet can be inserted, at 912, into the grooves. Adhesive is applied, at 1114, to secure the feet to ballast block. Once the feet are secured to ballast block, additional assembly of solar tracker can be performed, at 1116, such as panel installation and electrical wiring.

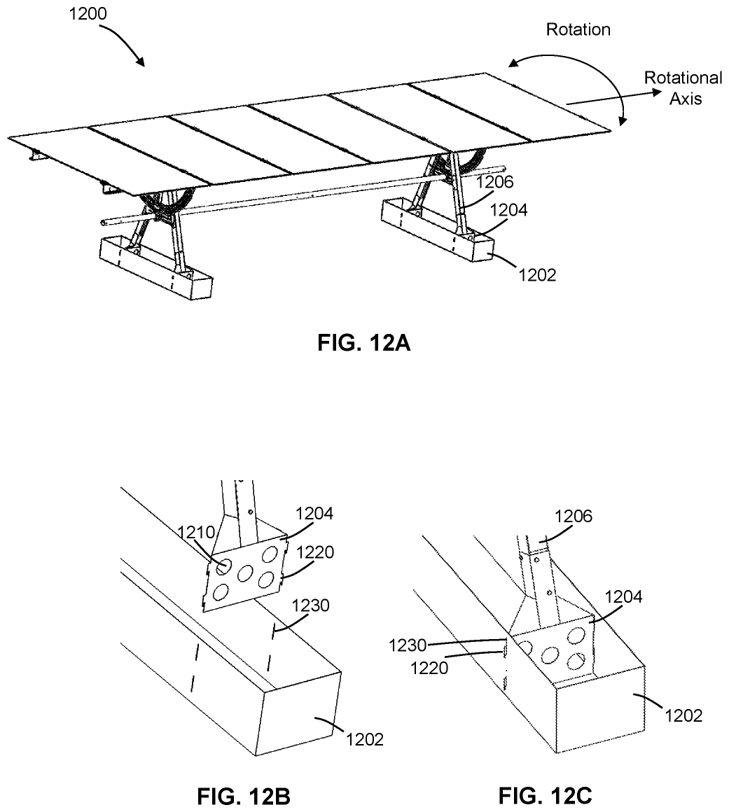

FIG. 12A schematically illustrates an example solar tracker 1200 that can be used to support and rotate solar modules, according to exemplary configurations provided herein. Solar tracker 1200 includes tracker legs 1206 and feet 1204 that can connect to a ballast block formed within ballast form 1202. In this variation, the ballast block in this configuration can be made of a material, such as concrete, that is cast in place into a form or mold. Tracker feet 1202 can interlock within ballast form 1202, as explained in more detail in FIGS. 12B-12C. Tracker feet 1204 can support the tracker, allow material to flow through them to anchor the tracker legs 1206 to ballast form 1202, and/or preserve the shape of ballast form 1202 (e.g., by preventing ballast form 1202 from bowing after the material is filled within the ballast form 1202).

FIG. 12B illustrates a perspective view of foot 1204 of solar tracker 1200. Foot 1204 can include a number of holes 1210 that allow material to flow through and surround foot 1204 when interlocked within ballast form 1202. Foot 1204 can also include a number of interlocking protrusions 1220. Ballast form 1202 can include a number of securing slots 1230. Interlocking protrusions 1220 can fit within slot 1230, and lock in place to secure foot 1204 within ballast form 1202 prior to pouring material into ballast form 1202. FIG. 12C schematically illustrates a perspective view of foot 1204 secured into place into ballast form 1202.

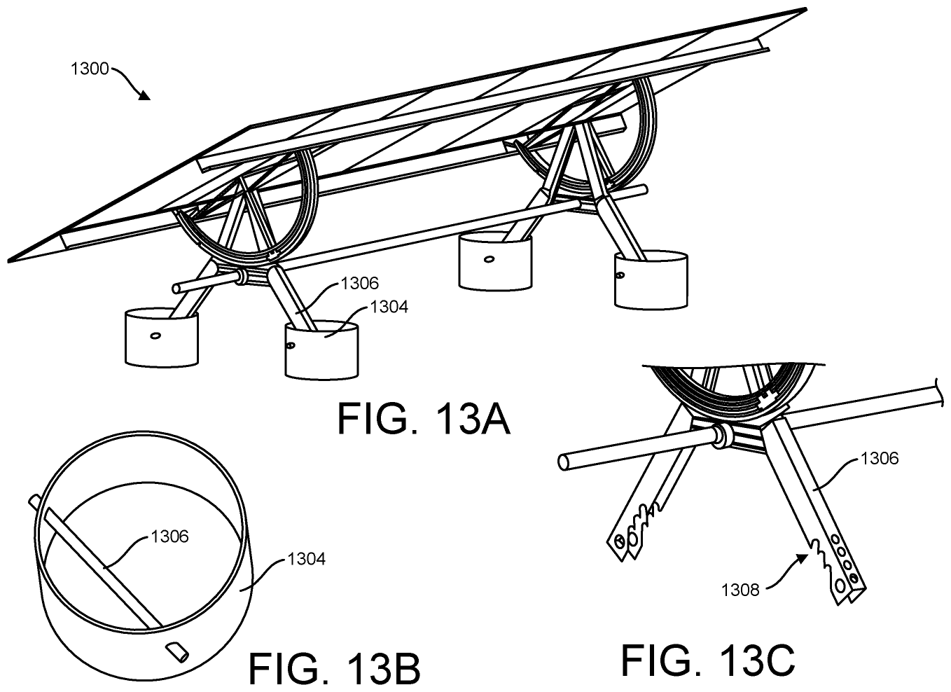

FIG. 13A schematically illustrates an example solar tracker 1300 that can be used to support and rotate solar modules, according to exemplary configurations provided herein. Solar tracker 1300 includes tracker legs 1306 and feet (not shown) that can connect to a ballast block formed within ballast form 1302. In this variation, the ballast block in this configuration can be made of a material that is cast in place into ballast form 1302, such as concrete. Legs 1306 can be inserted into ballast form 1302 prior to pouring of material within ballast form 1302 to form a ballast block. In this variation, each leg 1306 has its own corresponding ballast block.

FIG. 13B schematically illustrates an example ballast form 1304 of solar tracker 1300. Ballast form 1304 can include a reinforcement bar (e.g., rebar) 1306 to assist with the leveling of solar tracker 1300 as explained in more detail in FIG. 13C. In the configuration illustrated in FIGS. 13A-13B, ballast form 1304 is a circular shape. It can be appreciated that ballast form 1304 can be any type of shape, and a circular shape is shown for illustration purpose. There is one ballast form 1304 for each leg 1306.

Solar trackers can be installed on a variety of surface types and in a variety of different regions around the world. With varying surface types, grading of land can assist with creating a level surface. Some types of surfaces, for a variety of different reasons (e.g., economic or physical feasibility), may not be graded to a flat surface. An uneven surface could impact the operation of the solar tracker by, for example, being inefficiently exposed to sunlight or by being more prone to damage due to wind forces or other environmental conditions. For example, in a stow position, the solar panel modules of the solar trackers should be parallel to the surface on which the solar tracker is installed. Solar trackers can be protected from high winds when in a stow position. When solar trackers are installed on uneven surfaces, such as hilly or rocky surfaces, the stow position may not be parallel to the surface on which the solar tracker is installed. FIG. 13C schematically illustrates a leg 1306 which can assist with leveling the solar tracker in a stow position. Leg 1306 includes a number of leveling notches 1308. During installation of solar tracker 1300, a notch 1308 can be positioned on top of reinforcement bar 1306. The positioning of notch 1308 can assist with leveling out the solar tracker 1300. For example, one leg 1306 can be positioned to be on the bottom-most notch, while the other leg can be position on the top-most notch. The positioning can be chosen based upon the surface leveling of the surface on which the solar tracker 1300 is being installed. The positioning of the leg 1306 can occur prior to the pouring of material into ballast form 1304. Once the legs 1306 are positioned within ballast form 1304, the material can be poured to form a ballast block for each leg.

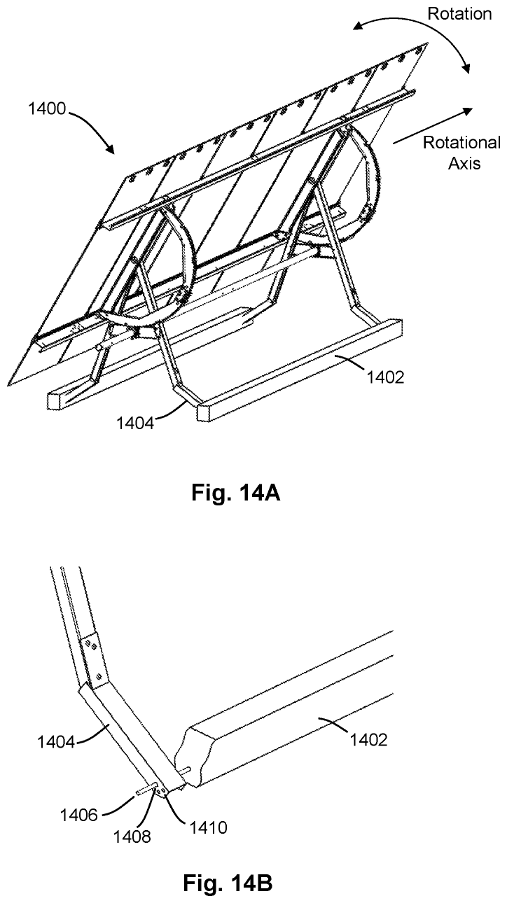

FIG. 14A-14B schematically illustrate perspective views of a solar tracker 1400 that can be used to support and rotate solar modules, according to exemplary configurations provided herein. Solar tracker 1400 includes feet 1404 that can connect to a ballast block 1402 by casting the concrete to form the ballast around the end of the foot 1404, thereby embedding part of the foot 1404 inside the ballast block 1402. The ballast block 1402 optionally can include one or more reinforcing bars 1406 embedded inside. The foot 1404 optionally can include holes 1408 through which a reinforcing bar 1406 can pass. Passing a reinforcing bar 1406 through a hole in the foot 1404 can form a mechanical lock between the foot 1404 and reinforcing bar 1406, which can strengthen the structure. The foot can include other holes 1410 that, when embedded in concrete, allow concrete to flow through the holes thereby enabling a mechanical lock between the bulk concrete and the metal foot. The ballast block 1402 optionally can include a control joint and/or a rod adhered to the surface that bridges the control joints.

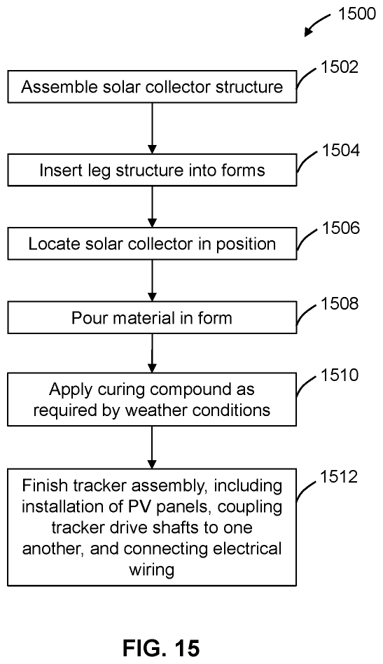

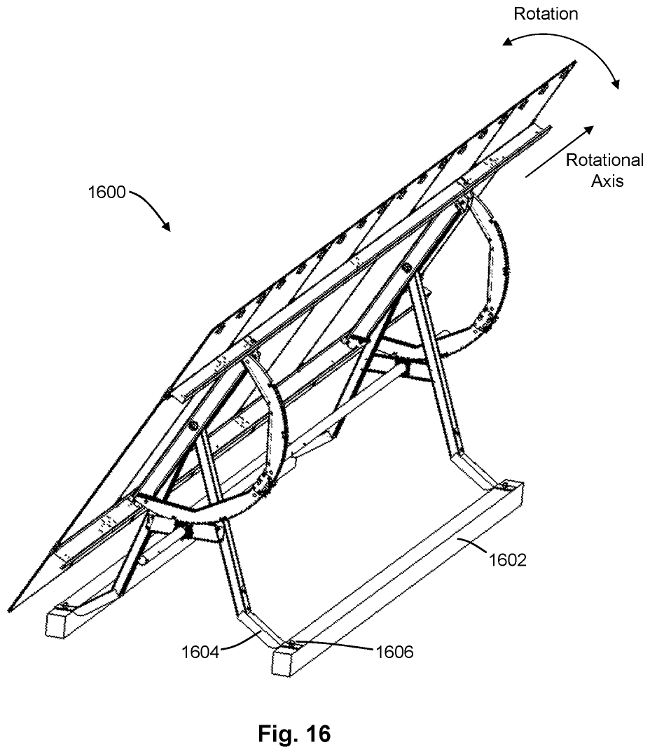

FIG. 15 is an example process flow chart 1500 for assembling a solar tracker having ballast block formed with a form, such as the solar tracker 1200 described in FIGS. 12A-12C and solar tracker 1300 described in FIGS. 13A-13C. The solar tracker can be assembled, at 1502. Such assembly can include assembling leg structures, drive tubes, any PV panel support members, and any gearing. The leg structure can then be inserted, at 1504, into an appropriate ballast form. For example, feet 1204 can be inserted into ballast form 1202 as described in detail in FIGS. 12A-12C. Similarly, leg 1306 can be inserted into ballast form 1304 as described in detail in FIGS. 13A-13C. The position of the structure along with the forms can be adjusted so that a row of solar trackers is properly aligned. Material, such as concrete, can then be poured, at 1408, into the ballast form. Such pouring can be performed manually or with the assistance of a machine. A curing compound can be applied, at 1510, if required. Once the ballast blocks are formed, any remaining tracker assembly, such as installing PV panels, coupling tracker drive shafts to one another, and connecting electrical wiring, can be completed, at 1512.

FIG. 16 schematically illustrates a perspective view of another solar tracker 1600 that can be used to support and rotate solar modules, according to exemplary configurations provided herein. Solar tracker 1600 includes feet 1604 that can connect to a ballast block 1602 with one or more fasteners 1606. Ballast block 1602 can be a pre-cast block formed prior to the solar tracker installation. The fasteners 1506 can be or include concrete anchors, concrete screws, bolts that are embedded in epoxy in a hole in concrete, or other suitable types of fasteners. The ballast block 1602 optionally can include one or more reinforcing bars embedded inside the ballast and/or optionally can include rods adhered to the surface that bridge control joints.

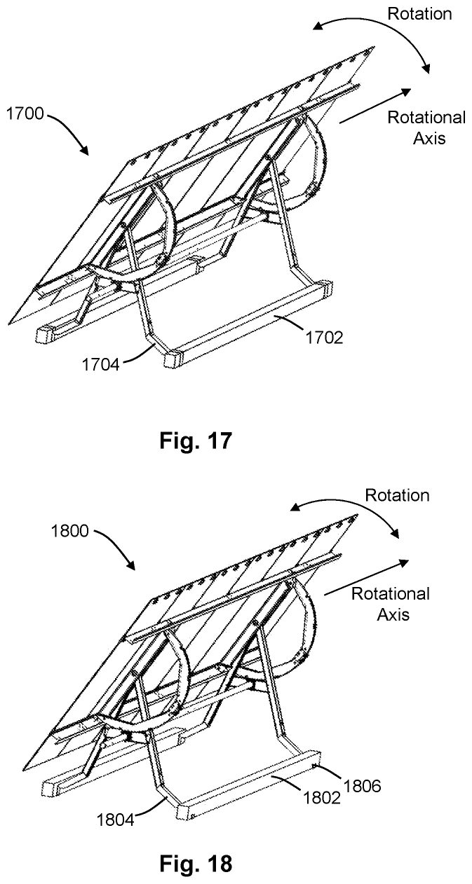

FIG. 17 schematically illustrates a perspective view of another example solar tracker 1700 that can be used to support and rotate solar modules, according to exemplary configurations provided herein. Solar tracker 1700 includes feet 1704 that can connect to a ballast block 1702 by wrapping around the ballast. Ballast block 1702 can be a pre-cast block formed prior to installation of solar tracker 1700. The ballast block 1702 optionally can include one or more reinforcing bars embedded inside it and/or optionally can include rods adhered to the surface that bridge control joints.

FIG. 18 schematically illustrate perspective views of a solar tracker 1800 that can be used to support and rotate solar modules, according to exemplary configurations provided herein. Solar tracker 1800 includes feet 1804 that can connect to a ballast block 1802 by providing a flat horizontal surface with vertical surfaces on two sides of feet 1804. The ballast block can sit on the feet 1804 to weigh down the feet. The ballast block 1802 optionally can include one or more reinforcing bars 1806 embedded inside it and/or optionally include reinforcing bars 1806 adhered to the surface that bridge control joints.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying FIGs. and/or described herein do not necessarily require the particular order shown, or sequential order, to achieve desirable results. Other implementations may be within the scope of the following claim.

What is claimed:

1. A solar tracker system comprising:
a solar photovoltaic (PV) module configured to rotate about a rotational axis;
a first leg structure and a second leg structure secured to the solar PV module at a first end; and
a first pair of ballast blocks comprising concrete secured to a second end of the first leg structure and a second pair of ballast blocks secured to a second end of the second leg structure,
wherein the first pair of ballast blocks are spatially separated from the second pair of ballast blocks and oriented parallel to the rotational axis, and
wherein each ballast block of the first pair of ballast blocks and the second pair of ballast blocks comprises a groove oriented lengthwise in each ballast block, the groove securing the first leg structure and the second leg structure to the respective pair of ballast blocks.

2. The solar tracker of claim 1, wherein the groove further comprises an adhesive.

3. The solar tracker of claim 2, wherein the adhesive secures the second end of the first leg structure and the second end of the second leg structure to the respective pair of ballast blocks.

4. The solar tracker of claim 1, further comprising a drive shaft positioned within each leg structure.

5. The solar tracker of claim 4, wherein the drive shaft configured to rotate the solar PV module about the rotational axis.

6. A solar tracking system comprising:
a first solar tracker and a second solar tracker, each solar tracker comprising:
a solar photovoltaic (PV) module configured to rotate about a rotational axis; and
a first leg structure and a second leg structure secured to the solar PV module at a first end; and
a pair of ballast blocks comprising concrete secured to the first leg structure of the first solar tracker and a second leg structure of the second solar tracker and oriented parallel to the rotational axis,
wherein each ballast block of the pair of ballast blocks comprises a groove oriented lengthwise, the groove securing the first leg structure of the first solar tracker and the second leg structure of the second solar tracker.

7. The solar tracker system of claim 6, wherein the groove further comprises an adhesive.

8. The solar tracker system of claim 7, wherein the adhesive secures the first leg structure of the first solar tracker and the second leg structure of the second solar tracker.

9. The solar tracker system of claim 8, each solar tracker further comprising a drive shaft positioned within each leg structure.

10. The solar tracker system of claim 9, wherein the drive shaft configured to rotate the solar PV module about the rotational axis.

11. A method of assembling a solar tracker, the method comprising:
simultaneously forming a pair of ballast blocks comprising concrete using a slip-form paver, the slip-form paver comprising a mold having a cut-off blade, by:
positioning the slip-form paver at a start point of the pair of ballast blocks, the cut-off blade in a closed position, the closed position halting flow of concrete;
advancing the slip-form paver to an end point of the pair of ballast blocks, while advancing:
simultaneously moving the cut-off blade to an open position, the open position permitting flow of the concrete through the mold depositing onto a solar tracker location; and
moving, after reaching the end point, the cut-off blade to the closed position;
forming grooves lengthwise in each ballast block; and
securing a leg structure of the solar tracker into the grooves.

12. The method of claim 11, wherein forming grooves comprises cutting each ballast block after formation.

13. The method of claim 11, wherein the mold comprises shapes that are inverse representations of the grooves.

14. The method of claim 11, further comprising applying a curing compound to the pair of ballast blocks.

15. The method of claim 11, wherein the leg structure further comprises feet.

16. The method of claim 15, wherein the securing of the leg structure of the solar tracker into the grooves comprises:
inserting the feet of the leg structure into the grooves; and
applying, after the inserting, an adhesive into the grooves.

17. The method of claim 11, further comprising forming a second pair of ballast blocks by repeating the positioning, advancing, moving, and depositing, wherein the second pair of ballast blocks are spatially separated from the first pair of ballast blocks.

18. The method of claim 11, wherein global positioning system (GPS) data controls the moving of the cut-off blade.

19. The method of claim 11, wherein the mold further comprises one or more vibrators.

20. The method of claim 19, wherein global positioning system (GPS) data controls the one or more vibrators.
